(19) United States
(12) Patent Application Publication
(10) Pub. No.: US 2009/0254298 A1
(43) Pub. Date: Oct. 8, 2009

(54) DETERMINATION OF A SURFACE TEMPERATURE OF A COOLING BODY

(75) Inventor: Stefan Harke, Wollerau (DE)

Correspondence Address: SUGHRUE MION, PLLC, 2100 PENNSYLVANIA AVENUE, N.W., SUITE 800, WASHINGTON, DC, 20037, US

(73) Assignee: Weidmann Plastics Technology AG, Rapperswil (CH)

(21) Appl. No.: 12/373,856

(22) PCT Filed: Jul. 11, 2007
(86) PCT No.: PCT/CH07/00336

§ 371 Date: Feb. 11, 2009

(30) Foreign Application Priority Data
Jul. 18, 2006 (CH) 1154/06

(51) Int. Cl. G01K 3/00; G06F 15/00; G01J 5/00

(52) U.S. Cl. 702/135

(57) ABSTRACT

In order to determine at least one surface temperature of an outside of a cooling body (2) at a time xn, at least one temperature measuring device (3) is used to measure the temperature at least one surface point of the outside of the body (2) at at least two different times after the production or processing method which was used to produce or process the body (2) has been concluded. On the basis of the temperatures measured, a temperature/time function (17) is calculated using regression analysis. The surface temperature at the time xn, which is before the at least two different times, is determined using the temperature/time function (17). The temperature at the time xn is used to optimize the production or processing method from which the body (2) results.

The invention relates to a method for the determination of at least one surface temperature of an outside of a cooling body after completion of the manufacturing method or the machining method with which the body was manufactured or machined. For this, the temperature is measured with at least one temperature measuring device at least at two different points in time at least at one surface point of the outside of the body. Based on the temperatures measured at least at two different points in time at least at one surface point of the outside of the body at least one temperature-time-function is calculated by means of regression analysis.

In the state of the art, it is also disclosed in EP1342550 A1 a method for the temperature determination. This document describes a method for the determination of the temperature of the inner and outer surface as well as the wall of a cooling preform, i.e. the temperature across the thickness of the preform. For this, by means of an infrared camera, after the preform has left a heating station and before it is placed into a blow molding machine, the outer surface temperature of the preform is measured at least two times during the cooling phase. The temperature measurement values are then plotted versus the time and, based on a given function, a temperature-time-function is determined by means of regression analysis. Using a further function as well as data of the temperature-time-function the temperature across the thickness of the cooling preform is then calculated immediately before its entry into the blow molding machine. By means of the knowledge of the temperature across the thickness the subsequent blow mold process or the quality of end product resulting from the blow molding process, respectively, can be optimized.

Disadvantageous to this method according to EP1342550 A1 is that it allows only the determination of temperatures of intermediate products in order, based on these, to control better a subsequent step processing the intermediate product. In principle, this teaching allows therefore not the improvement of a step of a manufacturing method or a step of a machining process due to temperature data which is measured at a product resulting from such a method step. That's why, in particular no manufacturing methods, such as the injection molding process, are optimizable. Additionally, the method is limited to the determination of temperatures across the thickness of intermediate products, on the basis of which the subsequent manufacturing step, by means of which the intermediate product is further manufactured, is optimized. The determination of the temperature across the thickness of a body described in EP1342550A1 is very time-consuming.

The object of the invention is therefore to provide a method for the determination of at least one temperature of a body which allows to optimize the manufacturing method or the machining method, in particular the step of the manufacturing method or the step of the machining method, from which the body results. Additionally the method should determine temperatures in an easy way based on which such a manufacturing method or machining method is optimizable.

The object is solved by the generic method such that at least one surface temperature at least at one point in time xn is determined, which is previous to the at least two different points in time, using the at least one temperature-time-function, whereby the at least one surface temperature determined at the at least one point in time xn is suitable for the optimization of a method by means of which the body was manufactured or machined.

The inventive method relates to a method for the determination of at least one surface temperature of an outside of a cooling body. The term “outside of a body” defines the side of a body which surface temperature can be measured by means of a temperature measuring device. For example, in case of a contact thermometer, it is the side which is tangible by means of the thermometer. In the case of an infrared camera or a thermo image camera, respectively, the outside of the body is the side, which can be in the visual field of the camera. The term “cooling” means that the surface temperature of the body adjusts to the environmental temperature of the body, whereby the environmental temperature is lower than the surface temperature of the body.

In a first step, according to the method, the temperature is measured with at least one temperature measuring device at least at two different points in time at least at one surface point of the outside of the body after completion of the manufacturing method or the machining method by means of which the body was manufactured of machined. Normally, the temperature measurement is performed by means of one temperature measuring device. But if the knowledge of the temperature is necessary at body parts at a specific point in time, which is not measureable with a single temperature measuring device, several temperature measuring devices, according to the case, have to be used. Preferably, the body, at which the temperature is measured according the invention, is a plastic part. The performance of the temperature measurement at for example two different surface points P0, P1 of a cooling body and at three different points in time t3, t4, t5 leads for example to the following temperature measurement values T:

T3 at the point in time t3 at surface point P0
T4 at the point in time t4 at surface point P0
T5 at the point in time t5 at surface point P0
T6 at the point in time t3 at surface point P1
T7 at the point in time t4 at surface point P1
T8 at the point in time t5 at surface point P1 whereby the following applies:
t3<t4<t5 with t in seconds [s]
T3>T4>T5, T6>T7>T8 with T in degree Celsius [° C.]

The measured temperature measurement values are then correlated with the time by calculating at least one temperature-time-function by means of regression analysis. The temperature-time-function is a regression function of the following form: T=f(t) or t=f(T), whereby for example the following applies: T=temperature in degree Celsius [° C.] and t=time in seconds [s]. The temperatures can e.g. also expressed in Kelvin and the time can be expressed in minutes etc. The term “regression analysis” is understood as statistical method for the analysis of data and emerges from the object to describe one-sided statistical dependencies by means of a regression function. As regression function can be used for example linear functions, square functions and exponential functions or also polynomial functions. The correlation of the temperature measurement values with the time can also be made by firstly plotting the measurement values versus the time. This is done e.g. in such a way, that in case of a diagram the x-axis is defined as time axis and the y-axis is defined as temperature axis or vice versa. Based on the example above, in such a temperature-time-diagram, where the x-axis represents the time and the y-axis represents the temperature, the following temperature-time-combinations are then plotted: (T3/t3), (T4/t4), (T5/t5), (T6/t3), (T7/t4), (T8, t5). In a further step the temperature progression versus the time of the temperatures plotted in the diagram are described with at least one temperature-time-function or the measured temperatures T are correlated with the time data t at which these temperatures T were measured, respectively.

Preferably, in connection with the inventive method, the following two regression analyses are performed, whereby preferably the calculation according to possibility 2 is applied:

### Possibility 1:

It is calculated a single temperature-time-function or cooling curve, respectively, of the body based on a part or all measured surface temperatures. In case of the example above, considering all temperature measurement values, the following temperatures are used for the calculation of the temperature-time-function:

T3 at the point in time t3 at the surface point P0
T4 at the point in time t4 at the surface point P0
T5 at the point in time t5 at the surface point P0
T6 at the point in time t3 at the surface point P1
T7 at the point in time t4 at the surface point P1
T8 at the point in time t5 at the surface point P1

### Possibility 2:

If at least at two surface points the temperatures are measured, then at least two temperature-time-functions are calculated.

This means, that for each single surface point a temperature-time-function, based on a part or all temperature measurement values, is determined. In connection with the example above, this leads to two temperature-time-functions, which, considering all temperature measurement values, are based on the following measurement values:

Temperature-time-function or cooling curve, respectively, for surface point P0:

T3 at the point in time t3 at the surface point P0
T4 at the point in time t4 at the surface point P0
T5 at the point in time t5 at the surface point P0

Temperature-time-function or cooling curve, respectively, for surface point P1:

T6 at the point in time t3 at the surface point P1
T7 at the point in time t4 at the surface point P1
T8 at the point in time t5 at the surface point P1

After the calculation of the at least one temperature-time-function, at least one surface temperature at least at a point in time xn, which is before the at least two different points in time, is determined using the at least one temperature-time-function. In case of the two examples above it is therefore calculated at least one surface temperature at least at a time x2, x1, x0 (xn with n=2, 1, 0) etc., which is before the point in time t3.

It was observed that the knowledge of the surface temperature of a body at the point in time of leaving the manufacturing apparatus or the machining apparatus, respectively, but also the knowledge of the body surface temperature within a certain time range after having left the apparatus, can be used for the optimization of the manufacturing method or the machining method, respectively, in particular of the manufacturing step or machining step, respectively, from which the body results. Surprisingly, it turned out that the temperature of the body has not to be measured compulsorily at the point in time of leaving the apparatus or at a desired point in time within a time range after leaving the apparatus. For the determination of an optimizing temperature it is sufficient, if, according to the inventive method, after the point in time at which the body leaves the apparatus or after a desired point in time within a time range after the body has left the apparatus, the temperature of the cooling body is measured. At each temperature measurement, it is additionally recorded, how much time has lapsed since the body has left the apparatus. These temperature data and time data are correlated by the calculation of a temperature-time-function by means of regression analysis. The temperature(s) of the body for the method optimization at the point in time xn, i.e. at leaving the manufacturing apparatus or machining apparatus or in a time range after leaving the manufacturing apparatus or machining apparatus, respectively, can subsequently determined by extrapolation of the calculated temperature-time-function(s) to the past or a desired point in time xn before the beginning of the temperature measurements. A temperature at the point in time xn within a time range after the body has left the manufacturing apparatus or the machining apparatus is for example useable for the method optimization, if the body is cooling slowly and therefore the body temperature during a certain time still corresponds about with the original body temperature at the time of leaving the apparatus. Whether such a case exists, the person skilled in the art can determine easily by means of the progression of the temperature measurements over the time which are used for the calculation of the temperature-time-function. The cooling velocity of a body depends among other things on the material of the body, its surface, the environmental temperature of the body etc. But preferably, by means of extrapolation of the temperature-time-function(s), the at least one surface temperature of the body at the time of leaving the manufacturing apparatus or machining apparatus or after completion of the manufacturing method or the machining method, respectively, is determined, since this temperature information is the best basis for a method optimization. The at least one point in time xn is therefore the point in time at which the body leaves the manufacturing apparatus or the machining apparatus. The manufacturing method is for example an injection molding method, a cupping method or an extrusion method. The machining method is for example a welding method.

According to a refinement of the invention, the at least one surface temperature at least at a point in time xn, which is before the at least two points in time, is displayed with a display, as for example an LCD-display of the temperature measuring device or a computer monitor.

Preferably, the body at which the at least one surface temperature is to be determined results from a manufacturing method, in particular from an injection molding method. In general, the inventive method can be applied to all cooling bodies, independent how this body was manufactured or machined.

By the application of the inventive method to a cooling injection mold part the injection molding method can among other things be optimized as following: the injection molded part can generally only be removed from the apparatus, when it is sufficiently cooled or the temperature of the part is below the melting temperature of the material of which it is made of in order to avoid in this way an undesired high deformation of the part at its removal from the injection molding machine. If the part is still left during a great time range in the apparatus as a precaution, in order to avoid the deformation, the cycle time of the injection molding method is increased unnecessarily and the operating efficiency of the method is lowered. The inventive method allows now the determination of the surface temperature of the injection molded part at its removal time of the apparatus. By means of the knowledge of this temperature the parameters of the injection molding method can be chosen or optimized such, respectively, that the removal takes place at the point in time at which the temperature of the injection molding part is sufficiently below the melting temperature of the material of which the body is made of. The temperature-time-function with which the cooling curve at the at least one surface point of a part manufactured by injection molding is describable is for example as following: y(x)=ax⁶+bx⁵+cx⁴+dx³+ex²+fx+g, whereby the following applies:

a,b,c,d,e,f,g=real numbers
y=temperature in degree Celsius [° C.] and x=time in seconds [s]or alternatively
y=time in degree Celsius [s] and x=temperature in degree Celsius [° C.]

Preferably the measurement of the temperature is performed at least at 20 different points in time, more preferably at least at 100 points in time. The more specified the desired temperature xn or the desired temperatures xn is/are to be determined, the more temperature measurements have to be performed. Typically, 5-60 seconds [s] pass until to a first temperature measurement after the manufacturing or the machining of the body or removal of the body from the machine, respectively. In case of a part manufactured by injection molding the time information made in the previous sentence relates preferably to the removal time of the part from the injection molding apparatus. Furthermore, the measurement of the temperature is preferably performed during at least 600 seconds [s], more preferably 3000 seconds [s]. Considering the parameters mentioned in this paragraph during the temperature measurement allows an efficient and exact determination of the desired body surface temperatures serving for the method optimization being timely before the measured surface temperatures of a body, in particular of a body manufactured by injection molding.

Preferably, the measurement of the temperature at least at one surface point at least at two different points in time is a measurement of the temperature distribution of at least one partial area, more preferably of the total area, of the surface of the outside of a body. For the temperature measurement, a body is preferably put on a surface, whereby the temperature distribution of at least one partial area, preferably of the total area of the surface seen from above and/or from the side of the outside of the body is measured.

For the calculation of the time-temperature-function preferably the lowest 20% and the highest 20% of all temperature measurement values, more preferably all temperature measurement values, are used. In contrast to single punctual measurements, an area temperature measurement leads to more measurement values and correspondingly also to a more precise determination of the temperature-time-function and therefore to the desired temperature at the point in time xn.

Preferably, the temperature measuring device functions contactless in order to avoid a deformation of the body. The temperature measuring device is then preferably a pyrometer, more preferably an infrared camera.

In case of an infrared camera, it measures preferably the temperature distribution of at least one partial area, more preferably of the total area, of a surface of the outside of a body being in the visual field of the infrared camera at least at two different points in time.

According to a refinement of the invention the infrared camera produces a temperature dependent picture of the body using the measured at least one temperature distribution at least at a desired point in time xn. A temperature dependent picture means a picture of a body which additionally shows the temperature distribution on the body surface, i.e. at which surface point which temperature exists. For the determination of such a picture the temperature-time-functions have to be calculated according to the possibility 2 described above. This allows the determination of the surface temperature progression at the single cooling surface points which constitute the at least one partial area or total area of the outside of the body, respectively, which is in the visual field of the infrared camera.

If temperature measurements at single different surface points are desired, it can be used, alternatively to a thermo picture camera or a pyrometer, also temperature measuring devices which punctually touch the surface of the body, such as a contact thermometer.

The invention relates furthermore to a temperature measuring device which comprises means for the performance of the inventive method described above. The temperature measuring device comprises an evaluation unit in which is implemented an algorithm for the determination of at least one surface temperature at least at one surface point of an outside of a body at least at one point in time xn. The at least one surface temperature at least at a point in time xn is suitable to optimize a method with which the body was manufactured or machined. The algorithm processes temperatures as input data measured at least at one surface point of an outside of a body at least at two different times, which preferably were determined by the temperature measuring device itself, and calculates based on these points in time and the temperatures measured at these points in time at least one temperature-time-function by means of regression analysis e.g. as described in connection with the inventive method. Subsequently, the algorithm determines the surface temperature at least at the point in time xn which is before the at least two different points in time using the at least one temperature-time-function by for example introducing the point in time xn into the temperature-time-function.

Preferably, the temperature measuring device comprises means for the display of the at least one surface temperature of the body at the at least one point in time xn such as an LCD-display.

According to a refinement of the invention the temperature measuring device comprises means for the time measurement. These are at least suitable to determine the time range between the point in time of a time measurement and the point in time at which the body has left the manufacturing apparatus or the machining apparatus. For this, it is sufficient if the temperature measuring device comprises the functions of a conventional stop watch. The time measuring apparatus has not necessarily to be integrated into the temperature measuring device. The time mentioned above can for example also be measured by hand with a stop watch which is separate from the temperature measuring device.

The invention further relates to a computer program as well as a computer and a memory medium onto which each this computer program is physically recorded. Said computer program comprises an algorithm executable by a computer for the calculation of at least one surface temperature at least at one point in time xn. The algorithm processes a temperature as input data measured at least at one surface point of an outside of a body at least at two different points in time wherein the algorithm calculates, based on these point in time data as well as the temperatures measured at these points in time, at least one temperature-time-function by means of regression analysis as well as determines the surface temperature at least at one point in time xn which is before the at least to different points in time using the at least one temperature-time-function. The at least one surface temperature at the at least one point in time xn is suitable to optimize a method by means of which a body was manufactured or machined. The computer program is preferably designed such that temperature measuring devices, in particular infrared cameras, can be equipped with it so that the inventive method can be performed using such an inventive temperature measuring device.

Alternatively to the evaluation of the measured surface temperatures by means of the inventive temperature measuring device, the temperature measurement values can also be transmitted for evaluation purposes to a computer with the above inventive computer program.

Further advantageous features emerge from the description which follows as well as the drawings. An embodiment of the invention is explained in more detail on the basis of the drawings.

It is shown by:

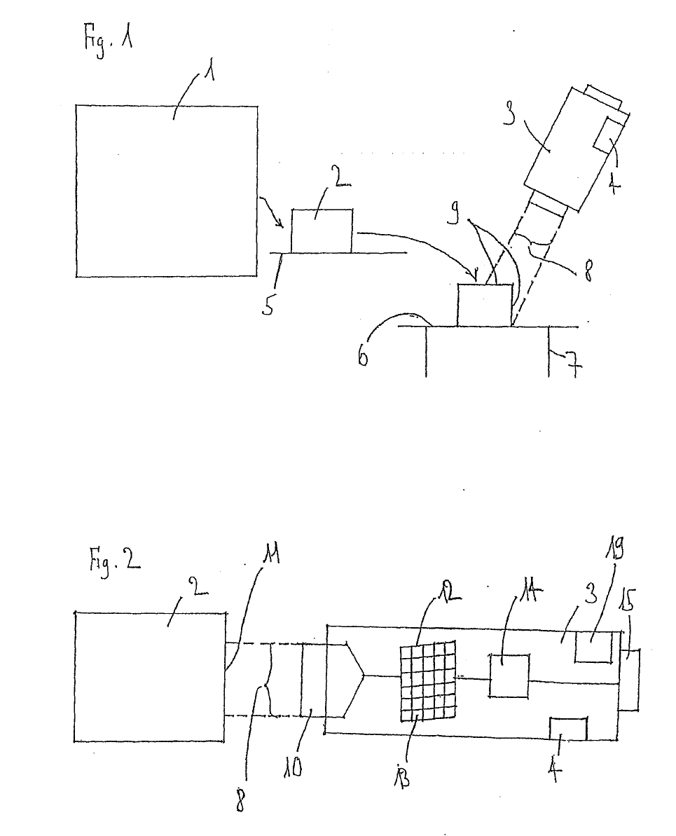

FIG. 1 schematically an injection molding machine as well as the surface temperature measurement at the manufactured cooling injection molded part by means of an infrared camera,

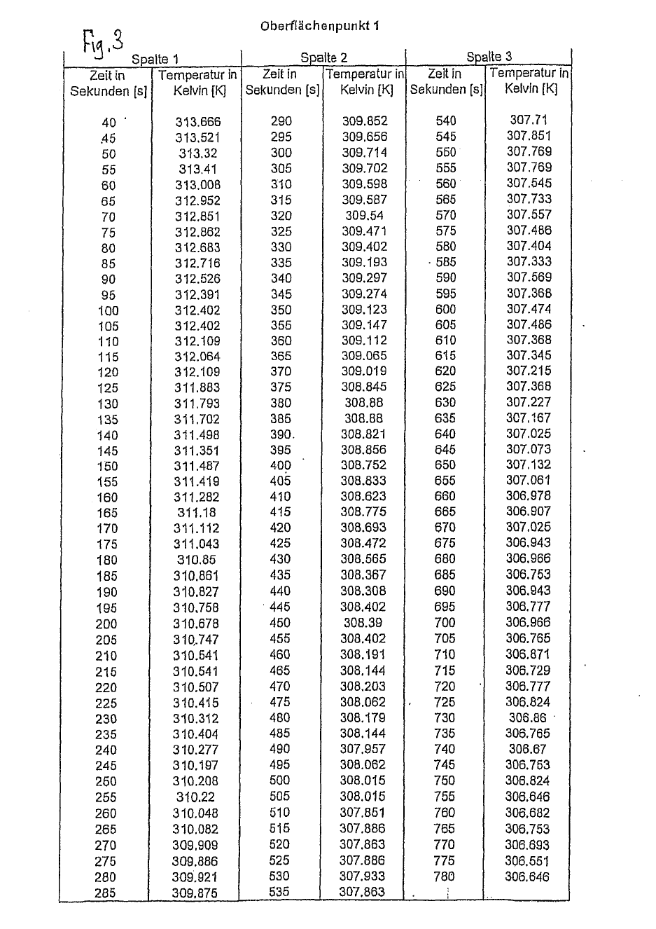

FIG. 2 schematically the infrared camera shown in FIG. 1 wherein the visual field is directed to a side area of the body according to FIG. 1,

FIGS. 3, 4 and 5 each a temperature-time-diagram with the surface temperatures measured by means of the infrared camera over the time at a surface point of a cooling injection molded part,

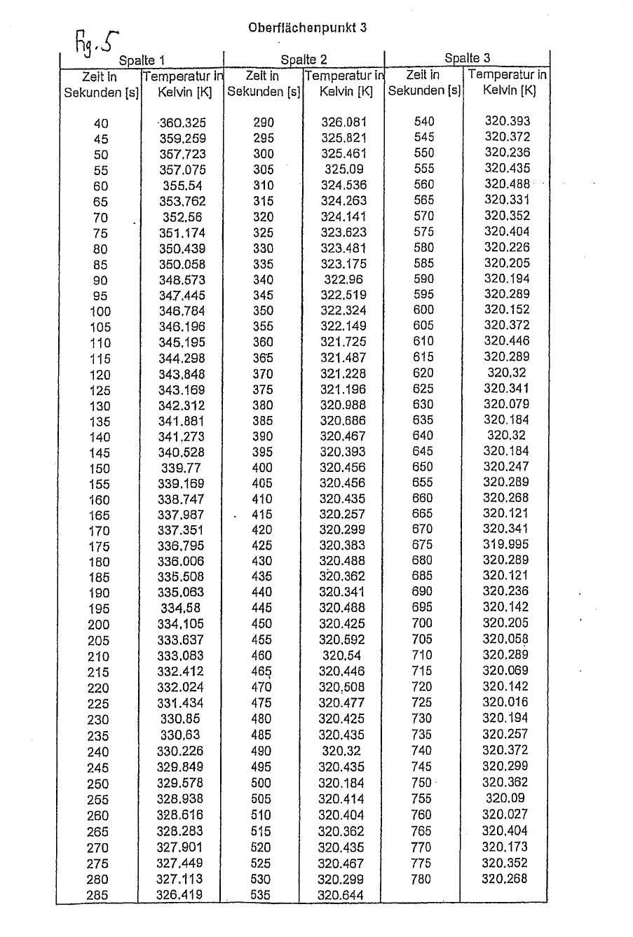

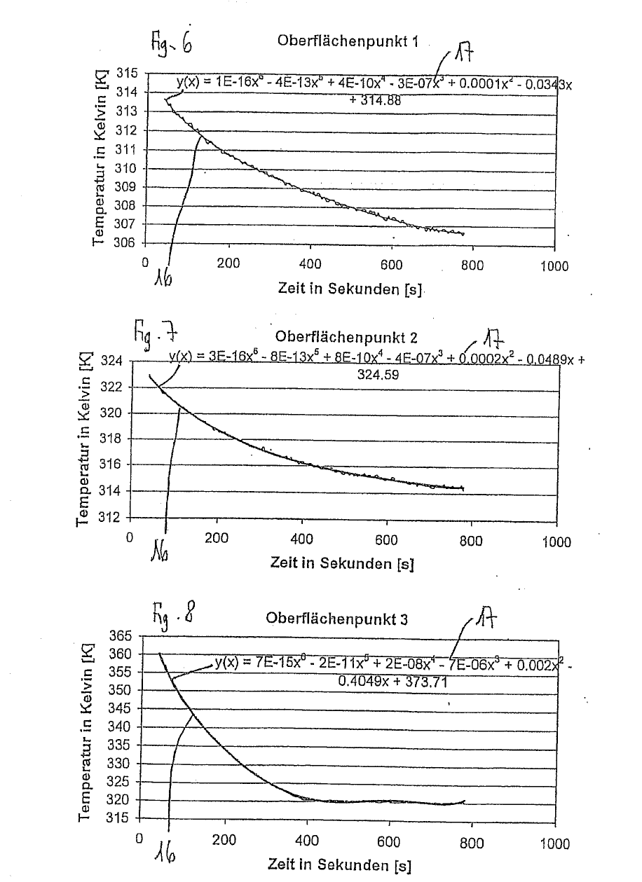

FIGS. 6, 7 and 8 each an illustration of a regression line or temperature-time-function (regression function), respectively, for one surface point in a temperature-time-diagram, whereby the temperature-time-function of each surface point was calculated based on the corresponding values of the temperature-time-diagram according to FIG. 3, 4 or 5,

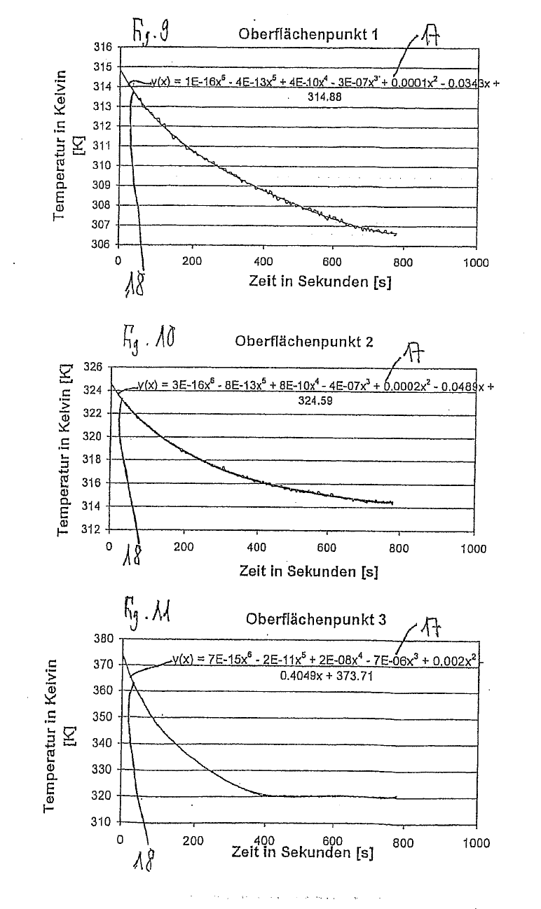

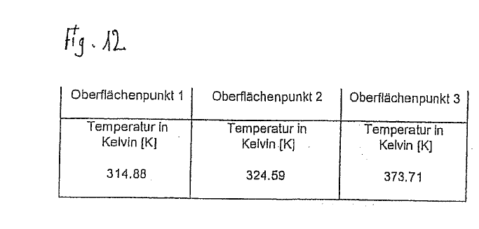

FIGS. 9, 10 and 11 the temperature-time-diagrams according to FIGS. 6, 7 and 8, whereby the regression lines are extrapolated to the zero point or the removal time of the injection molded part and

FIG. 12 a tabular compilation of the surface temperatures at the surface points according to FIGS. 9, 10 and 11 at the point in time xn, which is the removal time of the injection molded part from the injection molding machine or zero point of the temperature-time-diagrams according to FIGS. 6, 7, 8, 9, 10 and 11, respectively.

Reference sign 1 of FIG. 1 designates an injection molding machine by means of which a body 2, in particular made of plastics, is manufactured. The body 2 leaves at a point in time zero the injection molding machine 1. At this point in time it is started a time measuring apparatus 4 integrated into the infrared camera 3. Leaving the machine 1, the injection molded part 2 falls for example onto a conveyor belt 5, is cooled down on the conveyor belt and then is put by hand or for example by means of a gripper or a robot arm onto a surface 6, for example a table 7. Subsequently, by means of an infrared camera 3 it is measured the temperature distribution of a partial area 9 in the visual field 8 of the camera 3 of the cooling body 2 at least at two points in time and recorded by the camera 3. At the same time, the infrared camera 3 measures the time range between said point in time zero and the points in time of the temperature measurements and records these. Performing the temperature measurements the infrared camera 3 is e.g. attached to a tripod or held by a person (not shown).

The infrared camera according to FIG. 1 is schematically shown in FIG. 2 and comprises the same functions as infrared cameras of the state of the art. This type of camera is known by the person skilled in the art, but is shortly discussed as an example by means of FIG. 2. The infrared camera 3 comprises at least one lens 10, which focuses radiation impacting on the lens 10 of the side area 11 of the body 2, which surface temperature distribution is for example to be determined, on a detector 12. The detector 12 is normally a matrix of detector elements 13, whereby each element 13 pictures radiation of a corresponding area of the body 2. From the detector 12 the signals are introduced into a signal processing unit 14 for the signal processing. The picture of the body 2 recorded in the signal processing unit 14 is then transmitted to a display unit 15 of the infrared camera 3, which produces a conventional infrared picture of the partial area being in the visual field 8 of the side area 11 of the body 2. Reference sign 19 designates an evaluation unit.

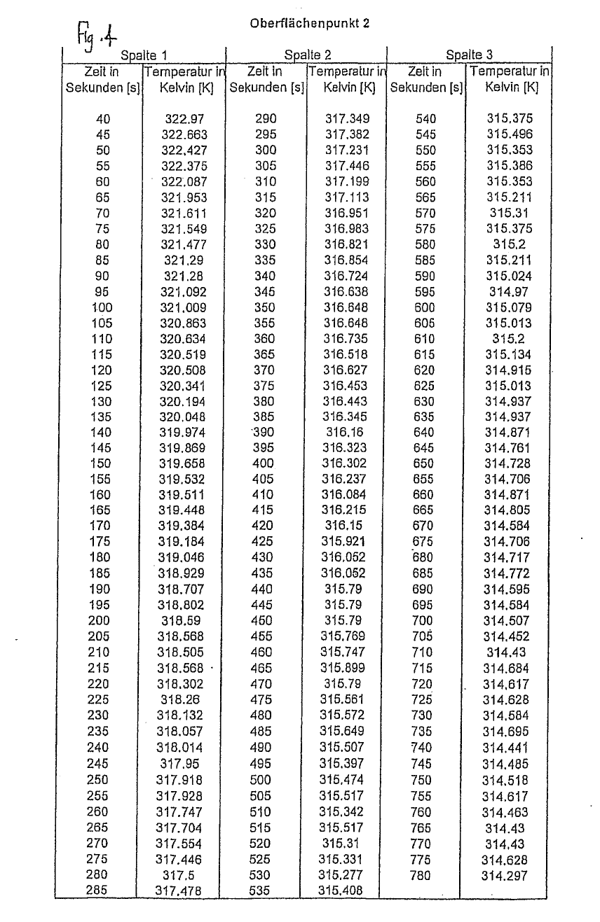

The surface temperatures measured by an infrared camera at different points in time at three different surface points of a cooling injection molded part 2 are illustrated in table form by the FIGS. 3, 4 and 5. For the temperature measurement an infrared camera A40 with an evaluation software ThermaCAM Researcher™ of FLIAR Systems GmbH, 60437 Frankfurt am Main, Germany was used. The injection molded part 2 or the body at which the temperature measurements were performed, respectively, is made of polypropylene, is designed for the engine compartment of an automobile and was manufactured by an injection molding machine of the type 650 of the company Krauss-Maffei Kunststofftechnik GmbH, Krauss-Maffei-Strasse 2, 80997 Munchen, Germany. For the injection molding manufacturing of the automobile part were chosen the following parameters: Mold temperature: 40° C., melting temperature: 240° C., cycle time: 50 s. The infrared camera comprised the adjustment that it is measured within the temperature range of 0-500° C. FIG. 3 lists in table form the temperatures measured by means of the infrared camera over the time at a surface point 1 of the body. For this, the table comprises columns 1, 2 and 3, whereby each of these columns is divided into a left and a right column. The left column comprises the points in time after removal of the body from the injection molding machine 1 at which the surface temperatures were measured. In the right column are recorded the measured surface temperatures at the respective points in time. This means for example that the first temperature measurement took place 40 seconds after the removal of the part from the injection molding machine, whereby at this point in time a surface temperature of 313.666 Kelvin was measured. At the “point in time” 290 seconds a surface temperature of 309.852 Kelvin and at the “point in time” 540 seconds a surface temperature of 307.71 Kelvin was measured. The FIGS. 4 and 5 are to read as described in connection with FIG. 3.

The data according to FIGS. 3, 4 and 5 were then transferred from the infrared camera to a computer and copied into the program “Microsoft Excel 2000” of Microsoft Corporation, Redmond, Wash. 98052-6399, UNITED STATES. The steps following now were performed with the temperature-time-data of each single surface point:
1. Format the time measurements into seconds as well as format the temperatures into degree Kelvin and subsequently mark the formatted data in black color
2. Click on the diagram-assistant
3. Choose the diagram type “point (XY)” and subsequently choose the diagram subtype “points with interpolated lines”
4. Click on the button “next”, whereby a temperature-time-diagram with a temperature-time-line of the respective surface point is displayed
5. Click on the button “next” and define the column axis (X) as time axis and define the column axis (Y) as temperature axis
6. Click on the button “finalize”, whereby the temperature-time-diagram with the temperature-time-line of the respective surface point is illustrated on an Excel-data sheet.
7. Touch with the cursor the temperature-time-line, press the right mouse button and choose “add trend line”
8. Choose the regression function with which the correlation of the temperature measurement values and the time measurement values according to FIGS. 3, 4 and 5 of each surface point should be described by means of clicking on the field “polynomial” and choose “sequence 6”. The choice of the field “polynomial” as well as “sequence 6” means that the correlation of the temperature measurement values and the time measurement values should be described by a polynomial sixth-power function calculated by means of regression analysis.
9. Click on the button “OK”. By means of this, a regression line is illustrated in the temperature-time-diagram, whereby this regression line is mathematically describable with a regression function or a temperature-time-function, respectively, calculated by regression analysis according to the point 8. above
10. With the cursor touch the regression line according to point 9., press the right mouse button and choose “format trend line”, then “options” and subsequently “illustrate equation in diagram”. By means of these steps, in the above temperature-time-diagram according to point 9. it is illustrated the polynomial function according to point 8.

The regression lines 16 (non serrated line) or the regression functions 17, respectively, which were calculated based on the surface temperature/time data according to FIGS. 3, 4 and 5 and according to the procedure according to the points 1.-10., are illustrated in the temperature-time-diagrams of the FIGS. 6, 7 and 8. The x-axis of the diagrams is the time axis which indicates the points in time after the removal of the injection molded part in the unit “seconds” at which the surface temperature at one surface point of the part was measured. The zero point of the x-axis corresponds therefore to the removal point in time of the part from the injection molding machine. The y-axis of the temperature-time-diagrams is the temperature axis which indicates the temperatures in the unit “Kelvin”. As apparent, all temperature-time-functions 17 correspond to a polynomial function of the following general type: y(x)=ax⁶+bx⁵+cx⁴+dx³+ex²+fx+g.

After the determination of the temperature-time-functions or the regression functions, respectively, based on the these, the surface temperature of the respective surface point of the injection molded part at the point in time xn, which is in the present embodiment the removal point in time of the part or the zero point, respectively, of the temperature-time-diagram, was then determined by means of the following further steps:
11. With the cursor touch the regression line 16 according to point 9., press the right mouse button, choose “format trend line” and subsequently set at “trend backwards:” the number of the desired “units”. In case of the measurement example according to the FIGS. 3, 4 and 5 the first temperature measurement at the three surface points 1, 2, 3 was performed 40 seconds after removal of the injection molded part from the mold. In order to extrapolate the regression line 16 to the zero point of the x-axis of the temperature-time-diagram or the removal point in time xn of the injection molded part, respectively, 40 units have consequently to be chosen and the button “OK” has to be clicked. Through this, in the temperature-time-diagram according to point 9., it is illustrated a regression line 18 (non serrated line) extrapolated to the zero point of the diagram or the removal point in time xn, respectively. Such extrapolated regression lines 18 are illustrated in the FIGS. 9, 10 and 11 for each surface point 1, 2, 3. The extrapolated regression lines 18 of the FIGS. 9, 10 and 11 result from the extrapolation of the regression line 16 according to FIGS. 6, 7 and 8 to the removal point in time xn.
12. The surface temperature of the injection molded part at the removal point in time xn at the respective surface point 1, 2 or 3 corresponds to the intersection of the extrapolated regression line 18 and the y-axis of the temperature-time-diagram (see FIGS. 9, 10 and 11) or can be calculated by introduction of the value 0 into the regression functions 17 mentioned in the FIGS. 6, 7, 8, 9, 10 and 11 describing the regression lines 16, 18. Said regression functions 17 correspond, as apparent, to the following general form: y(x)=ax⁶+bx⁵+cx⁴+dx³+ex²+fx+g. Therefore, the temperature at the removal point in time xn corresponds to the variable g of this general function. The respective temperature measurements calculated for each of the surface points 1, 2 or 3 at the removal point in time xn are contained in the table according to FIG. 12.
13. Besides the surface temperatures measured at the three surface points 1, 2 or 3 of the automobile part (FIGS. 3, 4 and 5) it was measured the temperature by means of the camera A40 at the points in time mentioned in the FIGS. 3, 4 and 5 at further ca. 30,000 surface points of the automobile part. For each of these points it was calculated, in the same way, as described in connection with the three surface points 1, 2, 3 according to FIGS. 3, 4 and 5 (cp. above points 1.-12.), the surface temperatures at the point in time xn. Subsequently, it was produced, using all calculated surface temperatures at the removal point in time xn, a temperature dependent picture of the automobile part at the removal point in time xn. The surface points which comprise the highest temperatures were marked with red colour, the surface points with middle temperatures with yellow colour and the surface points with the lowest temperatures with blue colour.

1. Method for the determination of at least one surface temperature of an outside of a cooling body at least at a point in time xn, whereby the at least one surface temperature is suitable for the optimization of a method with which the body was manufactured or machined comprising the following steps:
Measurement of the temperature with at least one temperature measuring device at least at two different points in time at least at one surface point of the outside of the body after completion of the manufacturing method or the machining method with which the body was manufactured or machined,
Calculation of at least one temperature-time-function by means of regression analysis based on the temperature measured at the at least two different points in time at least at one surface of the outside of the body,
Determination of the at least one surface temperature at the at least one point in time xn which is before the at least two different points in time using the at least one temperature-time-function.

2. Method according to claim 1, wherein the at least one surface temperature at the at least one point in time xn is displayed on a display.

3. Method according to claim 1, wherein the at least one point in time xn is the point in time at which the manufacturing method or machining method is completed.

4. Method according to claim 1, wherein the manufacturing method or the machining method is a manufacturing method, in particular an injection molding method.

5. Method according to claim 1, wherein the measurement of the temperature at least at two different points in time is performed within at least 600 seconds, preferably 3000 seconds.

6. Method according to claim 1, wherein the measurement of the temperature is performed at least at two different points in time, preferably at least at 20 points in time, more preferably at least at 100 points in time.

7. Method according to claim 1, wherein the temperature distribution of at least one partial area, preferably of the total area, of the surface of the outside of the body is measured.

8. Method according to claim 1, wherein the body is put on a surface, whereby the temperature distribution of at least one partial area, preferably of the total area of the surface visible from above of the outside of the body is measured.

9. Method according to claim 1, wherein the temperature measuring device does not touch the outside of the body during the measurement of the temperature.

10. Method according to claim 1, wherein the at least one temperature measuring device is selected from the group consisting of pyrometer, thermal element and infrared camera.

11. Method according to claim 1, wherein the at least one temperature measuring device is an infrared camera.

12. Method according to claim 11, wherein the infrared camera measures the temperature distribution of at least one partial area, preferably of the total area of the surface of the outside of the body in the visual field of the infrared camera at the at least two different points in time.

13. Method according to claim 1, wherein the lowest 20% and the highest 20% of all temperature measurement values, preferably of all temperature measurement values, are used for the calculation of the at least one temperature-time-function.

14. Method according to claim 12, wherein the infrared camera produces a temperature dependent picture of the body at least at one point in time xn using the temperature distribution measured at the at least two different points in time.

15. Temperature measuring device for a method according to claim 1 comprising an evaluation unit in which an algorithm for the determination of at least one surface temperature of an outside of a cooling body at least at one point in time xn is implemented, whereby the at least one surface temperature is suitable for the optimization of a method with which the body was manufactured or machined, which algorithm processes a temperature as input data measured at least at one surface point of the outside of the body at least at two different points in time, wherein the algorithm calculates at least one temperature-time-function by means of regression analysis based on the temperature measured at least at two different points in time at least at one surface point of the outside of the body as well as determines the at least one surface temperature at least at one point in time xn, which is before the at least two different points in time using the at least one temperature-time-function.

16. Temperature measuring device according to claim 15, wherein the at least one temperature measuring device comprises means for the time measurement.

17. Computer program for a temperature measuring device according to claim 15 comprising an algorithm processable by a processor for the calculation of at least one surface temperature of an outside of a cooling body at least at one point in time xn, whereby the at least one surface temperature is suitable for the optimization of a method with which it was manufactured or machined, whereby the algorithm processes a temperature as input data measured at least at one surface point of the outside of the body at least at two different points in time, wherein the algorithm calculates at least one temperature-time-function by means of regression analysis based on the at least at two different points in time at least at a surface point of the outside of the body as well as determines the at least one surface temperature at least at one point in time xn which is before the at least two different points in time using the at least one temperature-time-function.

18. Computer, onto which a computer program according to claim is physically recorded.

19. Storage medium, onto which a computer program according to claim 17 is physically storaged.
